(19) United States
(12) Patent Application Publication
(10) Pub. No.: US 2006/0075505 A1
(43) Pub. Date: Apr. 6, 2006

(54) Method and system for dynamic multi-level licensing of mobile data services

(75) Inventors: Vikas Murthy, Bangalore (IN); Karthik Mahadevan, Bangalore (IN)

Correspondence Address: William L. Botjer, PO Box 478, Center Moriches, NY, 11934, US

(73) Assignee: JULY SYSTEMS INC.

(21) Appl. No.: 10/954,857

(22) Filed: Sep. 30, 2004

(51) Int. Cl. H04N 7/16

(52) U.S. Cl. 726/26

(57) ABSTRACT

A system and method for generating and dynamically implementing multi-level licenses for accessing mobile content through a mobile network. The multi-level license is defined by a user in the form of a tree structure, whose nodes represent the different licenses that can be selected by a client. The client can select one or more license(s) from a set of license options available at that node. Each license option is associated with a license consisting of a license type and a price. The license type may be a count-based access license, duration-based access license, or an unlimited access license. The license(s) selected by the client is tracked by the system. As soon as the associated license expires, the client is presented with a next set of license options, in accordance with the multi-level license. The user can also analyze the financial aspects of the multi-level license by associating probability with each node in the tree structure.

### BACKGROUND

The present invention relates generally to the field of mobile networking. More specifically, the present invention provides a system and method for generating a multi-level license for accessing mobile content through a mobile network. The present invention also provides a system and method for dynamically implementing the multi-level license.

A license is a permit required for accessing mobile content through the mobile network. Examples of mobile content include java games, video clips, wallpapers, ring tones and other such data services. A user can be a mobile service provider, mobile content provider, or any other individual/organization interested in licensing out mobile content to a client. The client/end user is the party that accesses mobile content through the mobile network.

In today's market, the competition among various service providers has significantly increased. As a result, the service providers are in constant pursuit of new methods for defining licenses so as to retain their client base and to increase their revenue. In pursuit of this goal, each service provider is coming out with more ways for defining licenses and making them flexible, so as to suit all kinds of clients. These service providers can grow licensing revenue by reaching new, untapped markets and by offering a wider range of licensing options to existing subscribers. On these lines, service providers have started issuing flexible packages of mobile content to clients. Flexible packaging allows the service providers to bundle a set of mobile content and create a package that meets the client's need.

U.S. patent application number 20020091645 entitled ‘Software Licensing System’ provides a technique for enabling flexible licensing. The technique provides a system and method for allowing a client to define the license on the basis of the client's requirements. The client can choose the number of times, or the duration for which the service is required, and define the license accordingly.

However, the technique does not provide a dynamic enforcement of the license. Every time a license expires, there is no explicit provision for presenting another set of license options to the client, based on the previous license purchases of the specific client.

In light of the above discussion, there exists a need for a method and system for generating multi-level licenses, which can be used to provide new licenses to clients, once a license expires. The system should also be able to dynamically implement the generated multi-level licenses.

### SUMMARY

An object of the present invention is to provide a method and system for defining multi-level licenses for accessing mobile content through a mobile network. The multi-level license is a set of licenses organized in a tree structure. Examples of mobile content include java games, video clips, wallpapers, ring tones, and other such data services.

Another object of the present invention is to provide a graphical user interface for generating multi-level licenses by a mobile content provider/licensor for accessing mobile content through a mobile network.

Yet another object of the present invention is to provide a method and system for dynamically implementing a generated multi-level license in a mobile network.

In accordance with one aspect, the present invention provides a method and system for defining multi-level licenses for accessing a resource through a mobile network.

A license is a permit for accessing the resources through the mobile network. The license has a set of license parameters associated with it. In accordance with one embodiment of the present invention, the set of license parameters comprises permission parameters, constraint parameters and requirement parameters.

A multi-level license is a set of licenses organized in a tree structure. A tree structure has at least one branch. Each branch of the tree structure has at least one node. Each node is a parent node or a child node or both. Each parent node is associated with zero or more child nodes and each child node is associated with at least one parent node. Each node depicts a license. Each license, as depicted by a node, may be a license that is being presently used, or has been used in the past, or the license that will be presented to the client after the expiry of the presently used license.

A license option is a license that will be presented to the client after the expiry of the presently used license. Each node in the tree structure is associated with zero or more such license options. These license options collectively forms a set of license options associated with the presently used license. The set of license options can also include the presently used license.

Each license can be represented by a set of descriptions describing the license. For example, the license for a 3 day use license priced at $2 could be described by the descriptions “3 Use-$2.00” or “Buy a 3 use license for USD 2.00”.

The system comprises a license tree editor and a node definition module. The license tree editor generates a node for the tree structure by selecting a node template from the group of node templates. A node template is a partially defined node, wherein the type of the license that is being depicted by the node template is predefined. In accordance with one embodiment of the present invention, the types of licenses are a count-based access license, a duration-based access license and an unlimited access license. Each license depicted by a node has a set of license parameters associated with the license based on the node type. In accordance with one embodiment, the present invention also provides a system and method for analyzing the financial parameters of the generated multi-level license.

In accordance with another aspect, the present invention provides a method for generating multi-level licenses. The method comprises the steps of selecting a node template from a group of node templates; defining a generated node by assigning values to a set of license parameters associated with the license that is depicted by the selected node template; and appending the defined node to the tree structure depicting multi-level license.

In accordance with another aspect, the present invention provides a graphical user interface for generating multi-level licenses. The graphical user interface comprises a node templates interface, a license tree builder, a node definition interface and a financial analysis interface. Each node depicts a license. Each license depicted by a node has a set of license parameters associated with it. A user of the GUI selects a node template from the node templates interface, and drags and drops the selected node template onto the license tree builder. The node definition interface defines the generated node by assigning values for the set of license parameters associated with the license that is depicted by the selected node template. The financial analysis interface analyses the tree structure corresponding to the multi-level license. This analysis is done in order to identify the gross expected value of financial return arising from the multi-level license, the maximum financial return generating path of the tree structure and additionally, the path that has highest probability of selection by the client.

In accordance with another aspect, the present invention provides a system and method for dynamically implementing multi-level licenses for accessing content through a mobile network. The system comprises a license transfer module, a license tree enabler, a license enforcement client and a license enforcement server. The license transfer module transfers the multi-level license to the client once the client agrees to abide by policies. The policies include payment required for accessing the resources. The license tree enabler is responsible for identifying the license options that are presented to the client, once the presently used license expires. The license enforcement client tracks the usage of the license using a decrementing counter. The license enforcement client is located at the client end and gets activated when client side tracking is employed. However, in the case where server side tracking is employed, the license enforcement server using the decrementing counter carries out the tracking of the usage of the license.

The decrementing counter decrements the available limit of constraint parameters, associated with the license, every time the client accesses a resource. The constraints can be time bound or number bound. Once the constraints reach a value of nil, the license enforcement client or the server enforcement module restricts the access to the mobile content and requests the license tree enabler for the next set of license options based on the current license from the multi-level tree structure. This enables the client to select a license dynamically from the next level license options.

### BRIEF DESCRIPTION OF THE DRAWINGS

The preferred embodiments of the present invention will hereinafter be described in conjunction with the appended drawings provided to illustrate and not to limit the invention, wherein like designations denote like elements, and in which:

FIG. 1 illustrates the environment in which present invention operates, in accordance with one embodiment of the present invention;

FIG. 2 is a block diagram illustrating the system for generating a multi-level license for accessing mobile content through the mobile network, in accordance with one embodiment of the present invention;

FIG. 3 is a block diagram of a license tree editor, in accordance with one embodiment of the present invention;

FIG. 4 is a block diagram of a node definition module, in accordance with one embodiment of the present invention;

FIG. 5 is a block diagram of a financial analysis module, in accordance with one embodiment of the present invention;

FIG. 6 is a flowchart illustrating the steps involved in the method for generating multi-level licenses for accessing mobile content through a mobile network, in accordance with one embodiment of the present invention;

FIG. 7 is a flowchart describing a detailed method for defining a multi-level license for accessing mobile content through a mobile network, in accordance with one embodiment of the present invention;

FIG. 8 is a screen shot of a graphical user interface (GUI) used for generating a multi-level license for accessing mobile content through a mobile network, in accordance with one embodiment of the present invention;

FIG. 9 is a screen shot of a GUI used for performing financial analysis of the multi-level license, in accordance with one embodiment of the present invention;

FIG. 10 is a block diagram illustrating the system for implementing multi-level licenses, in accordance with one embodiment of the present invention;

FIG. 11 is a flowchart describing a detailed method for implementing multi-level licenses for accessing mobile content through a mobile network, in accordance with one embodiment of the present invention.

### DESCRIPTION OF PREFERRED EMBODIMENTS

The present invention relates to the field of mobile networking. More specifically, it relates to the field of generating licenses by a mobile content server/provider/licensor for accessing mobile content through a mobile network.

A license is a permit that is provided to a client to enable access to mobile content through a mobile network. Examples of mobile content include java games, video clips, wallpapers, ring tones, and other such data services. The license is defined by the user of the system. The user may be a mobile service provider, mobile content provider, or any other individual/organization interested in licensing out mobile content to the client. The present invention provides a method and system for generating a multi-level license for accessing mobile content through the mobile network. The multi-level license has been defined in the form of a tree structure.

In accordance with one embodiment of the present invention, the nodes of the tree structure depict licenses. In accordance with one embodiment of the present invention, licenses are categorized as count-based access licenses, duration-based access licenses or unlimited access licenses. Each license depicted by a node has a set of license parameters associated with the license based on the node type. The values assigned to the set of license parameters controls the access to the mobile content.

In accordance with one embodiment of the present invention, the set of license parameters comprises permission parameters, constraint parameters and requirement parameters. A permission parameter defines the permissions that are granted along with the license to the client. For example, the permission parameter for a game can be ‘play’ or ‘download’, and for wallpapers can be ‘view’ or ‘download’.

A constraint parameter is based upon the type of license. The license can be a count-based access license, a duration-based access license, or an unlimited access license. The constraint value defines the magnitude of the constraint for any particular license type. The constraint value can be number based or duration based. For example, if the access to mobile content is granted for 10 days, then the duration-based access license parameter takes the value of 10. In case the access to mobile content is limited for 10 times, then the constraint parameter takes the value of 10.

In accordance with one embodiment of the present invention, a duration-based access license can be a relative duration-based access license or an absolute duration-based access license. In the relative duration-based access license the constraint parameter represents the number of days for which the resource can be accessed from the time the license was purchased. However, in the absolute duration-based access license, the constraint parameter represents the absolute time at which the license to access the resource expires. As an example, a constraint parameter can be represented as ‘play for 3 days’ in a relative duration-based access license and as ‘play till MM/DD/YYYY’ in an absolute duration-based access license, wherein MM\DD\YYYY represents a date on which the license will expire.

A requirement parameter is the financial amount to be paid by the client in return for access to mobile content under specified constraint parameters. For example, if a license option of the multi-level license has been defined as “play 3 times for the price of USD 1.50”, its definition includes ‘play’ as a permission parameter, ‘3 times’ as a constraint parameter and ‘USD 1.50’ as a requirement parameter.

A multi-level license is a set of licenses organized in a tree structure. A tree structure has at least one branch. Each branch of the tree structure has at least one node. Each node can be a parent node or a child node or both. Each node depicts a license. Each license as depicted by a node may be a license that is used presently, or has been used in the past, or the license that will be presented to the client after the expiry of the presently used license.

In the multi-level license depicted in a tree structure, there are child nodes and parent nodes. A child node is a node that has a node above it. The node that lies directly above the child node and is linked to the child node is called the parent node. All child nodes of a parent node lie at the same level in the tree structure. The child nodes of the parent node (that depicts the presently used license) collectively form the set of license options. In accordance with one embodiment of the present invention, the set of license options can include the presently used license. The client can choose one or more licenses from the set of license options.

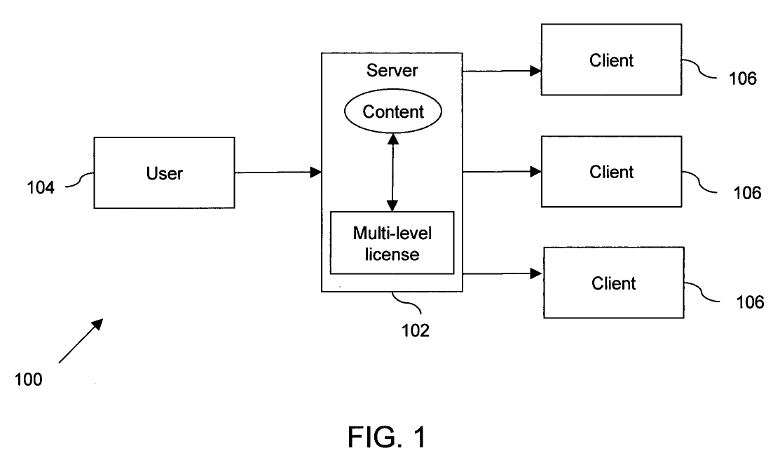

FIG. 1 shows the environment in which the present invention operates, in accordance with one embodiment of the present invention. The mobile network comprises at least one server 102, at least one user 104 and at least one client 106. Server 102 serves clients 106. Server 102 is a computer on a mobile network that is dedicated to a particular purpose of managing mobile content licensing. User 104 interacts with server 102 for defining the multi-level license. The defined multi-level license is used for accessing the mobile content. In accordance with one embodiment, mobile content is available on server 102 or on any other server connected to server 102 through LAN, WAN or any other mobile or non-mobile network. Client 106 needs to be provided with the multi-level license before allowing access to the mobile content.

Using a graphical user interface (GUI), user 104 generates the multi-level license. The graphical user interface is a part of the present invention. Server 102 stores the defined multi-level licenses and the associations between the content and the multi-level license.

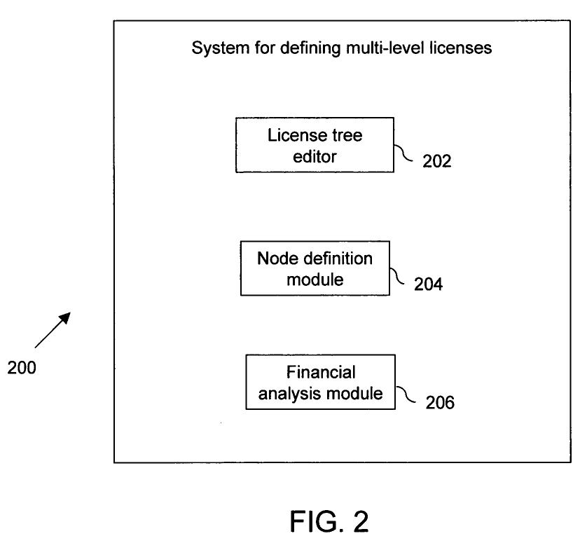

FIG. 2 is a block diagram illustrating a system 200 for defining a dynamic multi-level license for accessing mobile content through a mobile network, in accordance with one embodiment of the present invention. System 200 comprises a license tree editor 202, a node definition module 204 and a financial analysis module 206. License tree editor 202 generates the multi-level license for accessing mobile content, through the mobile network. The multi-level license is generated in the form of a tree structure. Node definition module 204 defines the nodes of the tree structure, which depicts the multi-level license. While defining a node of the tree structure, node definition module 204 assigns values to the set of license parameters attached with the license that is depicted by the node. Financial analysis module 206 analyses the financial aspects of the defined multi-level license. The financial aspects analyzed by financial analysis module 206 are the gross expected value of financial return from the defined multi-level license, the probability of selection for the maximum financial return generation branch of the tree structure depicting multi-level licenses, and the financial return generated by the branch, which has the maximum probability of being selected in the tree structure.

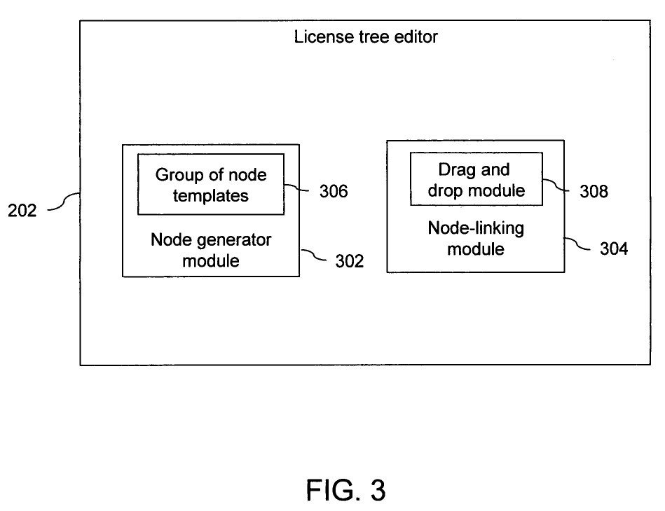

FIG. 3 is a block diagram of license tree editor 202, in accordance with one embodiment of the present invention. License tree editor 202 comprises a node generator module 302 and a node-linking module 304. In accordance with one embodiment, node generator module 302 further comprises a group of node templates 306. Group of node templates 306 comprises the nodes depicting different types of licenses. In one embodiment, group of node templates 306 represents license types such as count-based access licenses, duration-based access licenses and unlimited access licenses. In one embodiment of the present invention, node-linking module 304 further comprises a drag and drop module 308.

Node generator module 302 generates a node for the tree structure. The generated node depicts a license that is a part of the multi-level license. The node is selected from group of node templates 306. Node-linking module 304 links the generated node to the tree structure. In accordance with one embodiment of the present invention, the generated node is dragged and dropped on the tree structure using drag and drop module 308.

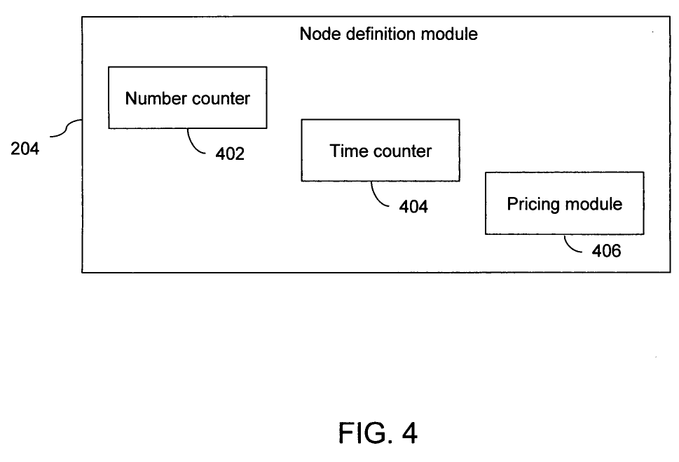

Once a node has been generated and linked to the tree structure, the license as depicted by the node needs to be defined. Each license has an associated set of license parameters. Node definition module 204 is used to assign a value to each parameter that belongs to the set of license parameters, as described in conjunction with FIG. 4.

FIG. 4 is a block diagram of node definition module 204, in accordance with one embodiment of the present invention. Node definition module 204 comprises a number counter 402, a time counter 404 and a pricing module 406. Number counter 402 is used to assign a value to the maximum number of times that the mobile content can be accessed by client 106. Time counter 404 is used to assign a value to the maximum time period for which the mobile content can be accessed by client 106. Pricing module 406 is used to assign a price value to the license represented by a node in the tree structure (that depicts the multi-level license). The price of the license is determined based on the values of the permission and constraint parameters associated with the license being offered.

As an example, if the license type depicted by the generated node is a count-based access license, then node definition module 204 is used to assign a value to the maximum number of times for which mobile content can be accessed. Accordingly, a price value is associated with the node. If the value assigned to the maximum number of times is 10 and the value assigned to the price is 5, the description of the license option would be ‘Play ten times for USD 5.00’. This means that client 106 can access the mobile content for ten times for an amount of ‘USD 5.00’.

In case the type of license depicted by the generated node is a duration-based access license, node definition module 204 assigns a value to the maximum time period for which mobile content can be accessed. Accordingly, a price value is attached to the node. The price value defines the amount that client 106 has to pay, in order to access the mobile content for the maximum time period. If the value assigned to the maximum time period is 5 days and the price value is 10, then the description of the license would be ‘Play five times for USD 10’. This means that client 106 can access the mobile content for five days by paying an amount of USD 10.

Similarly, if the type of license depicted by the generated node is unlimited access license, node definition module 204 assigns a value to the price attached to it. An example of a defined unlimited access license is ‘Unlimited access for USD 50’. This means that client 106 can access the mobile content for any number of times, by paying an amount of USD 50.

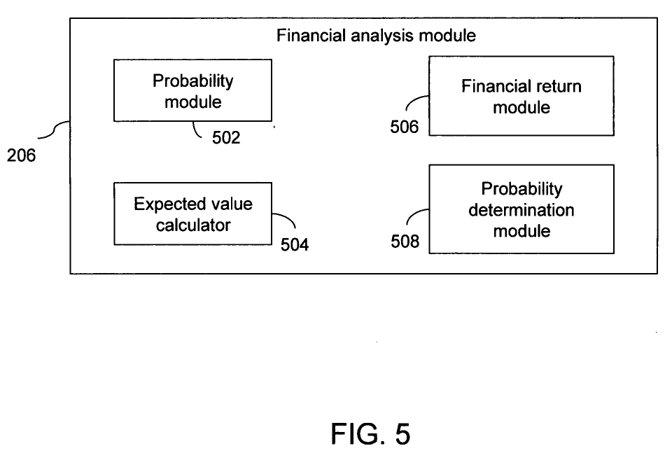

FIG. 5 is a block diagram of a financial analysis module, in accordance with one embodiment of the present invention. Financial analysis module 206 comprises a probability module 502, an expected value calculator 504, a financial return module 506 and a probability determination module 508. Probability module 502 enables user 104 to assign a probability value to each node of the tree structure that depicts the multi-level license. The probability value assigned to each node indicates the probability of the node being selected by a client. In one embodiment of the present invention, user 104 assigns the probability values. The probability values may be assigned based on the past experience of user 104, or on the statistical analysis of historical marketing and sales data for similar mobile contents. The probability values are required for analyzing the financial aspects of the defined multi-level license. Expected value calculator 504 calculates the gross expected financial return that can be expected from the mobile content if the defined multi-level license is implemented. In one embodiment of the present invention, the gross expected financial return from a node is calculated by multiplying the price associated with the node by the probability of reaching that node. The probability of reaching a given node is the probability of reaching the parent node multiplied by the probability assigned to the node. In one embodiment of the present invention, the gross expected financial return from each node in a branch/tree can be summed to calculate the gross expected financial return from the corresponding branch/tree.

It will be apparent to a person skilled in the art that the gross expected financial return can be calculated using other standard financial analysis techniques as well. The above-mentioned method of calculating the gross expected financial return arising from the multi-level license is just one of these techniques for calculating the expected financial return. In accordance with one embodiment of the present invention, the value of the gross expected financial return can be automatically re-calculated as the multi-level license depicted in a tree structure is modified. This enables the user to iteratively define the nodes of the tree depicting the multi-level license.

Financial return module 506 determines the path in the tree structure that generates the maximum financial return, in accordance with the definitions assigned to the licenses along with the probability value attached to each node of the multi-level license. Probability determination module 508 determines the path with the highest probability of being selected by the client, based upon the probability values assigned to each node in the tree structure depicting the multi-level license.

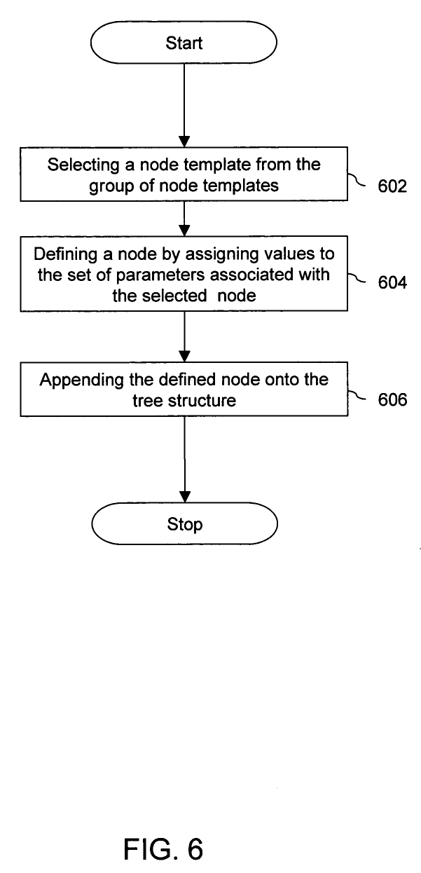

FIG. 6 is a flowchart illustrating the steps involved in the method for generating multi-level licenses for accessing mobile content through a mobile network, in accordance with one embodiment of the present invention. At step 602, a node template is selected. In accordance with one embodiment of the present invention, the node template is selected from a group of node templates. Group of node templates 306 represents the different license types. In one embodiment, group of node templates 306 represents license types such as count-based access licenses, duration-based access licenses and unlimited access licenses. In one embodiment of the present invention, node-linking module 304 further comprises a drag and drop module 308. The selected node template forms a node of the tree structure that depicts the multi-level license. At step 604, the generated node is defined. The definition given to the node is based upon the selected license type.

In accordance with one embodiment of the present invention, the nodes of the tree structure depict license types such as count-based access license, duration-based access license and unlimited access license. Each license depicted by a node has a set of license parameters associated with the license based on the node type. The values assigned to the set of license parameters controls the access to the mobile content.

In accordance with one embodiment of the present invention, the set of license parameters comprises permission parameters, constraint parameters and requirement parameters. A permission parameter defines the permissions that are granted along with the license to the client. For example, the permission parameter for a game can be ‘play’ or ‘download’, and for wallpapers can be ‘view’ or ‘download’.

A constraint parameter is based upon the license type. The license can be a count-based access license, a duration-based access license, or an unlimited access license. The constraint value can be number based or duration based. For example, if the access to mobile content is granted for 10 days, then the duration-based access license parameter takes the value of 10. In case the access to mobile content is limited for 10 times, then the constraint parameter takes the value of 10.

In accordance with one embodiment of the present invention, a duration-based access license of license can be classified as relative duration-based access license or absolute duration-based access license. In a relative duration-based access license, the constraint parameter represents the number of days for which the resource can be accessed from the time the license was purchased. In an absolute duration-based access license, the constraint parameter represents the absolute time at which the license to access the resource expires. As an example, a constraint parameter can be represented as ‘play for 3 days’ for a relative duration-based access license of license; and as ‘play till MM/DD/YYYY’ for an absolute duration-based access license of license, wherein MM\DD\YYYY represents a date on which the license will expire.

A requirement parameter is the financial amount to be paid by the client in return for access to the mobile content under specified constraint parameters. For example, if a license option of the multi-level license has been defined as ‘play 3 times for the price of USD 1.50’, its definition includes ‘play’ as a permission parameter, ‘3 times’ as a constraint parameter and ‘USD 1.50’ as a requirement parameter.

At step 606, the defined node is appended onto the tree structure that depicts the multi-level license. In accordance with one embodiment of the present invention, the step of appending is performed by dragging and dropping the defined node onto the tree structure.

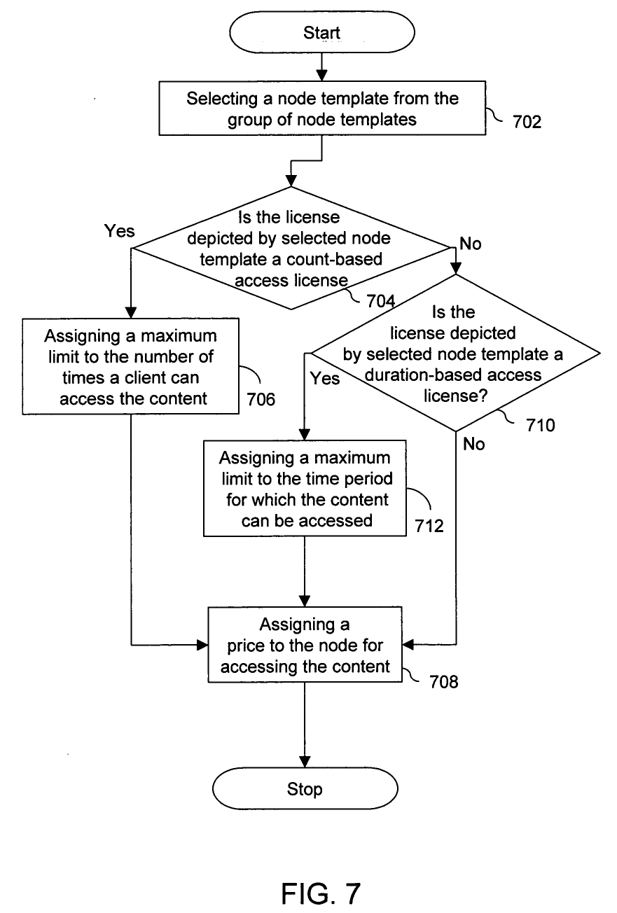

FIG. 7 is a flowchart describing a detailed method for defining a multi-level license for accessing mobile content through a mobile network, in accordance with one embodiment of the present invention. At step 702, a node template is selected from a group of node templates. In one embodiment of the present invention, the group of node templates depicts license types such as a count-based access license, a duration-based access license and an unlimited access license.

As described in conjunction with FIG. 6, the definitions given to the node are based upon the license type as depicted by the selected node template. At step 704, a check is performed to verify if the select ed node template depicts count-based access license. In case the selected node template depicts count-based access license, step 706 is performed. At step 706, a maximum limit is assigned to the number of times for which client 106 can access mobile content. The maximum number limit defines the constraint parameters associated with the license that is depicted by the selected node template. At step 708, a price value is assigned to the selected node template. The assigned price defines the requirement parameters for the selected node template.

However, if at step 704, it is found that the selected node template does not depict count-based access license, step 710 is performed. At step 710, a check is performed to verify if the selected node template is duration-based access license. If the selected node template is a duration-based access license, step 712 is performed. At step 712, a maximum limit is assigned to the time period for which the content can be accessed. Thereafter, step 708 is performed. At step 708, a price value is assigned to the selected node template.

However, as determined at step 710, if the selected node template does not depict duration-based access license, step 708 is performed. At step 708, a price value is assigned to the selected node template. In case the assigned price value for the selected node template is zero, mobile content is made available for free as per the definition assigned to the license.

In accordance with one embodiment of the present invention, user 104 performs the step of assigning values to the set of license parameters associated with each node of the tree structure depicting the multi-level license.

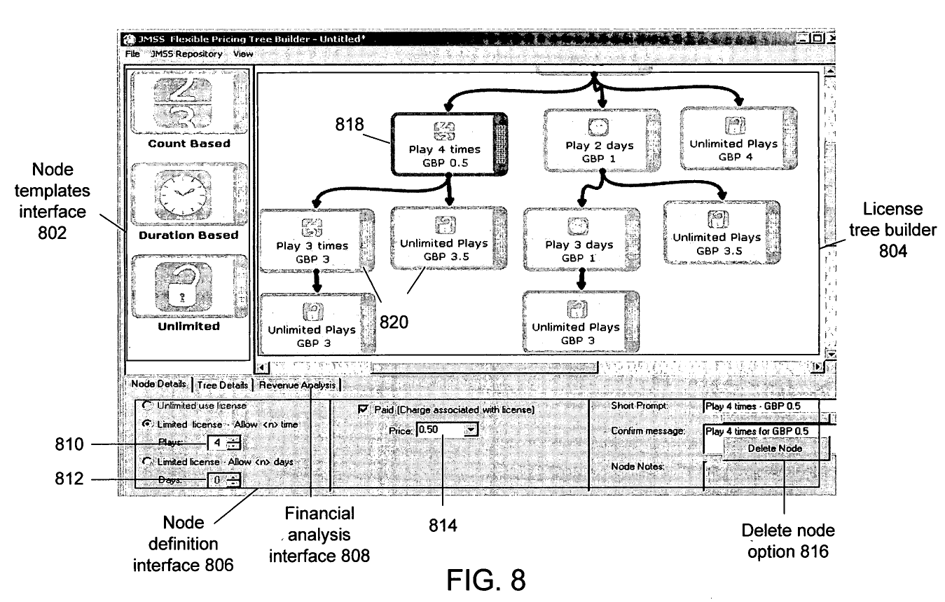

FIG. 8 shows a screen shot of a graphical user interface (GUI) used for generating multi-level licenses for accessing mobile content through the mobile network, in accordance with one embodiment of the present invention. The GUI comprises a node templates interface 802, a license tree builder 804, a node definition interface 806 and a financial analysis module 808. In accordance with one embodiment of the present invention, node templates interface 802 comprises interfaces for selecting the license types such as count-based access license, duration-based access license and unlimited access license. User 104 of the graphical user interface selects a node template from node templates interface 802. User 104 then drags and drops the selected node template onto license tree builder 804, using drag and drop module 308.

In accordance with one embodiment of the present invention, node definition interface 806 comprises a number counter interface 810, a time counter interface 812 and a pricing interface 814. Number counter interface 810 assigns a value to the maximum number of times for which mobile content can be accessed by client 106. Time counter interface 812 assigns a value to the maximum time period for which mobile content can be accessed by client 106. Pricing interface 814 assigns a price to each node of the tree structure that depicts the license. The assigned price is dependent on the definition given to the node.

As shown in FIG. 8, number counter interface 810 is activated only when the license type depicted by the selected node is count-based access license. In FIG. 8, the selected node represents count-based access license and hence only number counter interface 810 is activated for the selected node. In one embodiment of the present invention, node definition interface 806 further comprises a delete node option 816 for deleting the defined node from the tree structure.

Each node that depicts the license prompts a message. The prompt message is based upon the description given to each node. For example, in case the price assigned to a node as a requirement parameter is zero, the node shows ‘Free’ as the prompt message.

License tree builder 804 shows a tree structure depicting a generated multi-level license. The multi-level license has multiple levels of license options depicted in the form of a tree structure. Each level is defined based on the upper levels of the tree structure. The client has an option of selecting any license option from the license options that belong to the same parent node and are at the same level in the tree structure. As an example, if client 106 is presently using a license 818, then in case license 818 expires, client 106 gets another set of license options comprising child license 820. In accordance with one embodiment of the present invention, there is a provision for introducing loops in the tree structure. By providing a loop to a license, the same license is presented to the client along with other license options. The option of introducing loops has been associated with each node. While defining multi-level license, if a loop has been assigned to parent license 818, then parent license 818 is included in the set of license options that is presented to the client, once parent license option 818 (being used by the client) expires. License tree builder 804 enables the visualization of the multi-level license in the form of a tree structure.

In accordance with one embodiment, the present invention provides a system and method for analyzing the financial aspects of the defined multi-level license. The user of the GUI can additionally determine the various financial aspects of the generated tree structure.

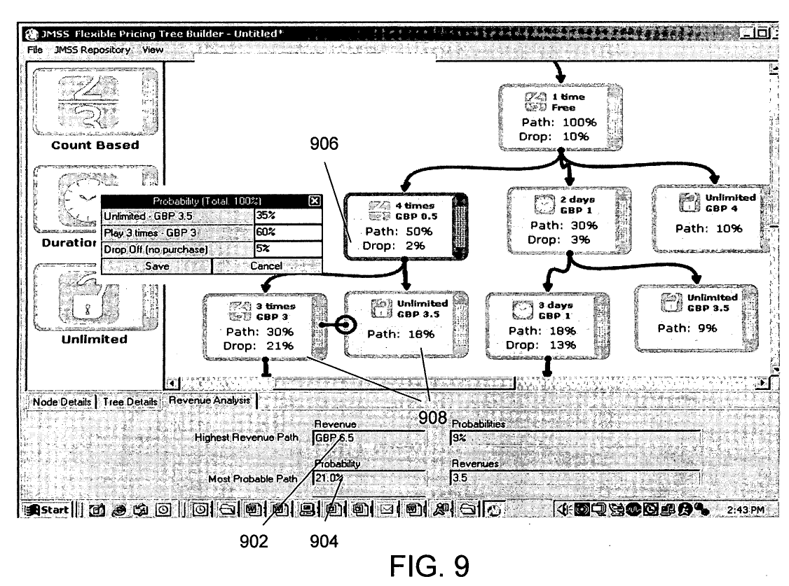

FIG. 9 is a screen shot of a GUI used for performing financial analysis of the multi-level license, in accordance with one embodiment of the present invention. The GUI comprises a revenue interface 902, a probability interface 904, a parent node 906, and a plurality of child nodes 908. The GUI enables the user to assign probabilities to each node of the tree structure. In accordance with one embodiment, the present invention enables user 104 to assign each child node belonging to child nodes 908 a probability value. The probability value assigned to child nodes 908 is indicative of the selection preferences of the clients having the license depicted by parent node 906. In accordance with one embodiment of the present invention, a drop percentage is introduced, wherein the drop percentage indicates the percentage of clients who would not select any child node 908, and also would not select any further licenses.

The GUI, as shown in FIG. 9, also illustrates a means for associating probabilities with each child node 908 after selecting a parent node 906. The associated probability is used for calculating the financial return expected from each client and also for determining the paths that have the highest probability of being selected and maximum financial return generation potential. FIG. 9 shows the GUI in the revenue analysis mode, wherein the determined paths with maximum financial return and highest probability are represented by the corresponding financial return and probability values.

As shown in the FIG. 9, revenue interface 902 depicts the revenue and probability associated with the determined path that promises the highest revenue. The highest revenue path is determined using the probabilities and revenue associated with each node in the tree structure, which depicts the multi-level license. In a similar way, probability interface 904 depicts the probability and revenue associated with the most probable path. The most probable path is determined using the probabilities associated with each node in the tree structure.

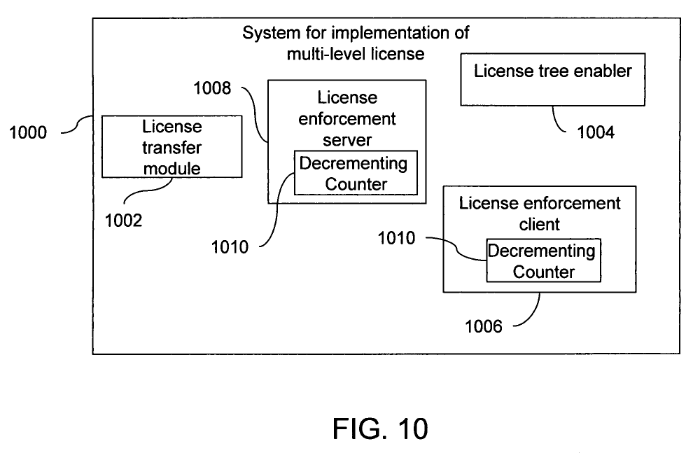

FIG. 10 is a block diagram of the system for implementing multi-level licenses, in accordance with one embodiment of the present invention. Implementation system 1000 comprises a license transfer module 1002, a license tree enabler 1004, a license enforcement client 1006, a license enforcement server 1008, and a decrementing counter 1010. In accordance with one embodiment of the present invention, decrementing counter 1010 is located in license enforcement client 1006 and license enforcement server 1008. License transfer module 1002 transfers a license to client 106 for accessing mobile content through the mobile network. The transfer of the license is performed after ensuring that payment for the license option has been made by client 106. In accordance with one embodiment of the present invention, the step of transferring the license can be performed using either combined delivery or separate delivery. In the case of combined delivery, the license is delivered along with the mobile content. In the case of separate delivery, the license is delivered separately from the mobile content.

The requirements for accessing mobile content are defined by the license parameters associated with the transferred license. License tree enabler 1004 enables client 106 to access to the mobile content. License tree enabler 1004 also presents a set of license options to client 106 to choose from, once the present license expires. The set of license options are identified by license tree enabler 1004, on the basis of the license being used presently by client 106.

The tracking of the transferred license is performed by dynamically updating the available limit for the associated constraint parameters as defined in the license. The constraint parameters, as described earlier, can be defined either as numbers (for a count-based access license option) or as duration (for a duration based access license option). The tracking of the usage of the transferred license can be performed either at the client side or at the server side. In the case of client side tracking, decrementing counter 1010 is located in license enforcement client 1006 and the count of the number, or the duration, gets decremented at the client end itself. Client side tracking is described in U.S. patent application Ser. No. 10/623,932 titled “Application Rights Management in a Mobile Environment” filed by July Systems Inc. on Nov. 7, 2003 the disclosure of which is hereby incorporated by reference.

However, in the case of server side tracking, decrementing counter 1010 is located in license enforcement server 1008 and decrements the count of the number or the duration at server 102 itself. The request for accessing mobile content is passed onto license enforcement client 1006 or license enforcement server 1008 based on the kind of tracking, as soon as the request is received from client 106. The module that receives the request determines the value of decrementing counter 1010 and returns a true or false value. If decrementing counter 1010 has a zero value, the module returns a false value. However, in case decrementing counter 1010 has a non-zero value, the module that received the request returns a true value. In case the returned value is true, access to mobile content is granted to client 106.

However, in case the returned value is false, client 106 is presented with another set of license options to choose from. The client is granted access to mobile content only after ensuring that the client has accepted to pay for the chosen license option.

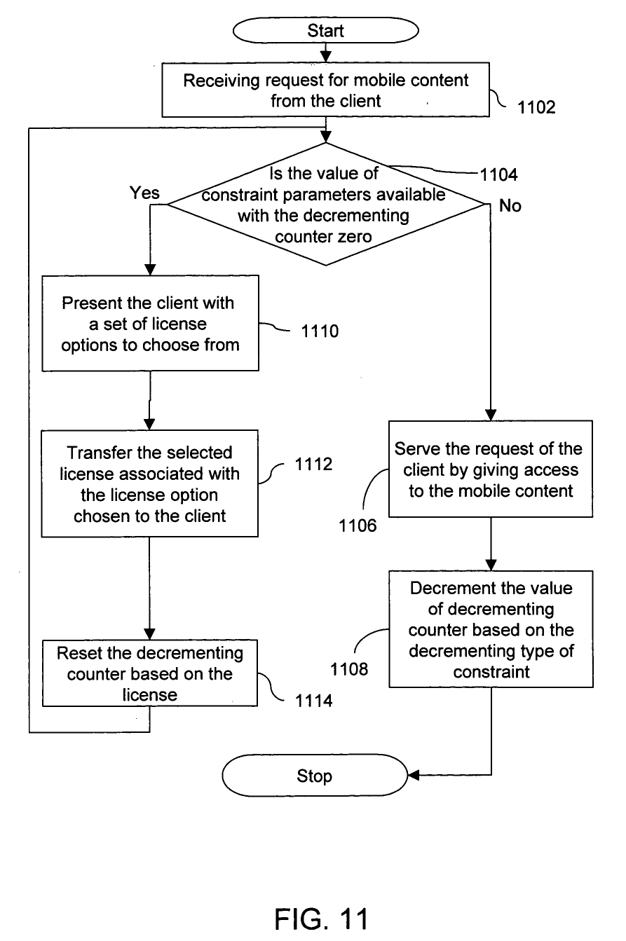

FIG. 11 is a flowchart describing a detailed method for implementing the multi-level license for accessing mobile content through a mobile network, in accordance with one embodiment of the present invention. At step 1102, a request is received from the client for accessing the mobile content, for which the license has already been transferred to the client. At step 1104, a check is performed for the available limit of the constraint parameters with the decrementing counter.

If the available limit of constraint parameters available with the decrementing counter is non-zero, step 1106 is performed. At step 1106, the request from the client is served by granting access to the mobile content. At step 1108, the available limit of the constraint parameters is decremented by one, in case the selected license is a count-based access license. In case, the selected license is a duration-based access license, the value of the constraint parameters is decremented after completion of a unit of time period, as defined in the selected license.

However, if the available limit of constraint parameters at the decrementing counter is zero, step 1110 is performed. At step 1110, the client is presented with next set of license options. At step 1112, the selected license option from the next set of license options is transferred to the client. At step 1114, the available limit of the constraint parameter is revised at the decrementing counter. The system after receiving another request from the client follows the steps starting from 1104.

Another aspect of the present invention is also described, in accordance with one embodiment of the present invention. The present invention provides a computer program product for use with a computer. The computer program product comprises a computer readable program code embodied therein for generating multi-level licenses for accessing mobile content through the mobile network. The computer readable program comprises an instruction means for selecting a node template from a group of node templates, an instruction means for defining a node by assigning values to a set of license parameters associated with the license that is depicted by the selected node template, and an instruction means for appending the defined node to the tree structure. In one embodiment of the present invention, the group of node templates depicts license types such as count-based access license, duration-based access license and unlimited access license. Each license type is having an associated set of license parameters for defining the node that depicts the license type.

The computer program product, as described above, has been built using the .Net platform. The languages that can be used in this platform include, but are not limited to, VB.Net, C++, C#, and J#. The computer program product can be developed using native Application Program Interfaces (APIs) supported by the Net framework. The GUI described above can also be developed using any of the languages supported by the .Net platform. The examples of such languages are mentioned above. A web version of the GUI that can be viewed through a browser (such as IE and Mozilla) can also be developed using applet, activex, Net or other such plug-in frameworks. The server can be developed using Java.

The system, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. Computer comprises a microprocessor. The microprocessor is connected to a communication bus. The computer also includes a memory, which may includes a Random Access Memory (RAM) and a Read Only Memory (ROM). The computer system further comprises storage device, which can be a hard disk drive or a removable storage drive such as a floppy disk drive, optical disk drive and the like. Storage device can also be other similar means for loading computer programs or other instructions into the computer system.

The computer system executes a set of instructions that are stored in one or more storage elements, in order to process input data. The storage elements may also hold data or other information as desired. The storage element may be in the form of an information source or a physical memory element present in the processing machine.

The set of instructions that are provided to the computer system may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands; or in response to results of previous processing; or in response to a request made by another processing machine.

The mobile content can be stored on multiple servers. The servers containing the mobile content are connected by a wired or wireless connection in a LAN, WAN, MAN, VPN or any other network.

An advantage of the present invention is that it is useful in the generation and visualization of the multi-level license in the tree structure form. The multi-level license enables mobile content providers to target various usage patterns and end user psychographics. As an example, a rental model for java games can be targeted to the youth where a user can rent a game for a week for a lower price than the full purchase price of the game. $1.00 as against $4.00.

Another advantage of the present invention is the dynamic enforcement of the multi-level license. As soon as a multi-level license option expires, the client is presented with the next set of license options to choose from. The set of license options is defined taking into account the previous license of the client. The user can buy the license based on the options presented and the license is updated inline. The user can immediately start playing the game without having to re-download the game or enter any license registration keys.

Yet another advantage of the present invention is that the user can analyze the various financial aspects of the multi-level license depicted in a tree structure. Using the GUI, the user can easily visualize the generated multi-level license and make suitable changes after analyzing the gross expected value of financial return that can be expected from the multi-level license. The user can also identify the branch that has the highest probability of being selected by the client. The user can also identify the branch having maximum financial return generation potential. These inputs can be used by the user 104 to readily analyze the various aspects of the multi-level license tree and prepare marketing strategies accordingly. The user can also make changes dynamically to the tree and the changes will be reflected in the analysis in real time.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A system for generating a multi-level license for accessing a mobile content through a mobile network, the multi-level license being a permit for accessing the mobile content, the system comprising:
a. a license tree editor for generating the multi-level license, the multi-level license being a set of licenses organized in a tree structure, the tree structure comprising at least one branch, each branch comprising at least one node; and
b. a node definition module for defining nodes, each node being a part of the generated multi-level tree structure and each node depicting a license for accessing the resource, the license being depicted in the form a node of the tree structure, the node being selected from a group of node templates, the group of node templates comprising nodes that depict license types including at least one of a count-based access license, a duration-based access license and an unlimited access license, each license having an associated set of license parameters that define the license.

2. The system, as recited in claim 1, wherein the license tree editor comprises:
a. a node-generator module for generating a node by selecting the node template from the group of node templates; and
b. a node-linking module for appending the generated node to the tree structure.

3. The system, as recited in claim 2, wherein the node-linking module comprises a drag and drop module for dragging and dropping the generated node onto the tree structure.

4. The system, as recited in claim 1, wherein, the node definition module comprises:
a. a number counter for defining a value for the maximum number of times for which the mobile content can be accessed, the number counter being activated wherein the license type depicted by the generated node is a count-based access license;
b. a time counter for defining a value for the maximum time period for which the mobile content can be accessed, the time counter being activated wherein the license type depicted by the generated node is a duration-based access license; and
c. a pricing module for assigning a price to the node, the price being a financial amount required for accessing the mobile content, the pricing module being activated wherein the license type depicted by the generated node is an unlimited access license.

5. The system, as recited in claim 1, further comprising a financial analysis module for analyzing the financial return from the multi-level tree structure.

6. The system, as recited in claim 5, wherein the financial analysis module comprises:
a. a probability module for assigning a probability value to a node belonging to the tree structure, the probability value being an indicator of the probability of the node being selected by a client;
b. An expected value calculator for calculating a gross expected value of financial return from the generated multi-level license, the gross expected value of financial return being a function of the values of the probability and the price associated with the node;
c. a financial return module for determining a maximum financial return generating branch of the tree structure, the maximum financial return generation being computed based upon the values of the probability and the price associated with each node belonging to the tree structure; and
d. a probability determination module for determining a branch having the highest probability of being selected by the client, the branch being a part of the tree structure, the branch with the highest probability being identified based on the values of the probability associated with each node belonging to the tree structure.

7. A method for generating a multi-level license for accessing a mobile content through a mobile network, the multi-level license being a permit for accessing the mobile content, the multi-level license being a set of licenses organized in a tree structure, the tree structure comprising at least one branch, each branch comprising at least one node, the method comprising the steps of:
a. selecting a node template from a group of node templates, the group of node templates comprising nodes that depict types of licenses, the types of licenses comprising count-based access licenses, duration-based access licenses and unlimited access licenses, each license having an associated set of license parameters that define the license;
b. defining a node by assigning values to the set of license parameters associated with the selected node template; and
c. appending the defined node to the tree structure.

8. The method, as recited in claim 7, wherein defining the node comprises the steps of:
a. assigning a maximum limit to the number of times for which the mobile content can be accessed, the step being performed wherein the license depicted by the generated node is a count-based access license;
b. assigning a maximum limit to the time period for which the mobile content can be accessed, the step being performed wherein the license depicted by the generated node is a duration-based access license; and
c. assigning a price to the node, the price being a financial amount to be paid by a client for accessing the mobile content, the step being performed wherein any node template from the group of node templates is selected.

9. The method, as recited in claim 7, further comprising the step of storing the appended tree structure in a license tree database.

10. A system for generating a multi-level license for accessing a mobile content through a mobile network, the multi-level license being a permit for accessing the mobile content, the system comprising:
a. a license tree editor for generating the multi-level license, the multi-level license being a set of licenses organized in a tree structure, the tree structure comprising at least one branch, each branch comprising at least one node, the license tree editor comprising;
i. a node-generator module for generating a node by selecting the node template from the group of node templates; and
ii. a node-linking module for appending the generated node to the tree structure;
b. a node definition module for defining nodes, each node being a part of the generated multi-level tree structure and each node depicting a license for accessing the resource, the license being depicted in the form a node of the tree structure, the node being selected from a group of node templates, the group of node templates comprising nodes that depict license types including at least one of a count-based access license, a duration-based access license and an unlimited access license, each license being depicted by node template having an associated set of license parameters that define the license, the node definition module comprising:
i. a number counter for defining a value for the maximum number of times for which the mobile content can be accessed, the number counter being activated wherein the license type depicted by the generated node is a count-based access license;
ii. a time counter for defining a value for the maximum time period for which the mobile content can be accessed, the time counter being activated wherein the license type depicted by the generated node is a duration-based access license; and
iii. a pricing module for assigning a price to the node, the price being a financial amount required for accessing the mobile content, the pricing module being activated wherein the license type depicted by the generated node is an unlimited access license.

11. The system, as recited in claim 10, further comprising a financial analysis module for analyzing the financial return from the multi-level tree structure.

12. The system, as recited in claim 11, wherein the financial analysis module comprises:
a. a probability module for assigning a probability value to a node belonging to the tree structure, the probability value being an indicator of the probability of the node being selected by a client;
b. a expected value calculator for calculating a gross expected value of financial return from the generated multi-level license, the gross expected value of financial return being a function of the values of the probability and the price associated with the node;
c. a financial return module for determining a maximum financial return generating branch of the tree structure, the maximum financial return generation being computed based upon the values of the probability and the price associated with each node belonging to the tree structure; and
d. a probability determination module for determining a branch having the highest probability of being selected by the client, the branch being a part of the tree structure, the branch with the highest probability being identified based on the values of the probability associated with each node belonging to the tree structure.

13. A method for generating a multi-level license for accessing a mobile content through a mobile network, the multi-level license being a permit for accessing the mobile content, the multi-level license being a set of license options organized in a tree structure, the tree structure comprising at least one branch, each branch comprising at least one node, the method comprising the steps of:
a. selecting a node template from a group of node templates, the group of node templates comprising nodes that depict types of licenses, the types of licenses comprising count-based access licenses, duration-based access licenses and unlimited access licenses, each license having an associated set of license parameters that define the license;
b. defining a node by assigning values to the set of license parameters associated with the selected node template, the step comprising; and
i. assigning a maximum limit to the number of times for which the mobile content can be accessed, the step being performed wherein the license depicted by the generated node is a count-based access license;
ii. assigning a maximum limit to the time period for which the mobile content can be accessed, the step being performed wherein the license depicted by the generated node is a duration-based access license;
iii. assigning a price to the node, the price being a financial amount to be paid by a client for accessing the mobile content, the step being performed wherein any node template from the group of node templates is selected; and
c. appending the defined node to the tree structure.

14. A system for implementing a multi-level license for accessing a mobile content through a mobile network, the multi-level license being a permit for accessing the mobile content, the multi-level license being a set of licenses organized in a tree structure, the tree structure comprising at least one branch, each branch comprising at least one node, the system comprising:
a. a license transfer module for transferring a license to a client for accessing mobile content through the mobile network, the license belonging to the set of license options given to the client;
b. a license enforcement client for dynamically tracking the usage of the transferred license, the license enforcement client being activated wherein the client side tracking is employed, the license enforcement client being located at the client end;
c. a license enforcement server for dynamically tracking the usage of the transferred license, the license enforcement server being activated wherein the server side tracking is employed, the license enforcement server being located at the server end; and
d. a license tree enabler for identifying a set of license options for presenting to a client, the set of license options being selected based on the position of a license, which is presently being used by the client, in the multi-level license.

15. The system, as recited in claim 14, further comprising a decrementing counter for decrementing an associated constraint parameter, the associated constraint parameter limiting the access to the mobile content, the decrementing counter being located in the license enforcement client wherein client side tracking is employed, the decrementing counter being located in the license enforcement server wherein server side tracking is employed.

16. A method for implementing a multi-level license for accessing a mobile content through a mobile network, the multi-level license being a permit for accessing the mobile content, the multi-level license being a set of licenses organized in a tree structure, the tree structure comprising at least one branch, each branch comprising at least one node, the method comprising the steps of:
a. providing a client access to the mobile content, the license being a part of the multi-level license, the selected license comprising an associated constraint parameter and a requirement parameter, the associated constraint parameter limiting the access to the mobile content, the requirement parameter being the financial value that is paid by the client for accessing the mobile content;
b. decrementing the associated constraint parameter, the step being performed every time the mobile content getting accessed by the client; and
c. presenting to the client license options from the multi-level license, the license options being dependent on the position of a license, which is presently being used by the client, in the multi-level license.

17. A graphical user interface for generating a multi-level license, the multi-level license being a set of licenses organized in a tree structure, the graphical user interface comprising:
a. a node templates interface, the node templates interface comprising interfaces for license types including count-based access licenses, duration-based access licenses and unlimited access licenses, each node template having an associated set of license parameters for defining the license option;
b. a license tree builder for building the tree structure, the tree structure comprising at least one branch, each branch comprising at least one node;
c. node definition interface for defining the nodes belonging to the tree structure, the node definition module interface assigning values to the license parameters associated with a selected node template; and
d. a financial analysis interface for analyzing financial return from the tree structure.

18. The graphical user interface as recited in claim 17, wherein the node definition interface comprises:
a. a number counter interface for assigning a value to the maximum number of times for which the mobile content can be accessed, the number counter interface being activated wherein the license depicted by the selected node template is a count-based access license;
b. a time counter interface for assigning a value to the maximum the time period for which the mobile content can be accessed, the time counter interface being activated wherein the license depicted by the selected node template is a duration-based access license; and
c. a pricing interface for assigning a price to the node, the price being a financial amount required for accessing the mobile content, the pricing interface being activated wherein a node template belonging to the group of node templates is selected.

19. A computer program product for use with a computer, the computer program product comprising a computer usable medium having a computer readable program code embodied therein for generating a multi-level license for accessing a mobile content through a mobile network, the multi-level license being a permit for accessing the mobile content, the multi-level license being a set of license options organized in a tree structure, the tree structure comprising at least one branch, each branch comprising at least one node, the computer program product performing the steps of:
a. selecting a node template from a group of node templates, the group of node templates comprising nodes that depict the types of licenses, the types of licenses comprising count-based access licenses, duration-based access licenses and unlimited access licenses, each license being depicted by a node template having an associated set of license parameters for defining the license option;
b. defining a node by assigning values to the set of license parameters associated with the selected node template; and
c. appending the defined node to the tree structure.
